(19) United States
(12) Patent Application Publication
(10) Pub. No.: US 2010/0263186 A1
(43) Pub. Date: Oct. 21, 2010

(54) Apparatus and Method for Repairing the Tubular End of a Vehicle Differential

(76) Inventors: Antonio Vale Bele, Buenos Aires (AR); Juan Antonio Vale Bele, Buenos Aires (AR)

Correspondence Address: AMIN TALATI, LLC, 225 North Michigan Avenue, Suite 700, CHICAGO, IL, 60601, US

(21) Appl. No.: 12/761,084

(22) Filed: Apr. 15, 2010

(30) Foreign Application Priority Data
Apr. 15, 2009 (AR) P20090101330
Apr. 15, 2009 (AR) P20090101331

(51) Int. Cl. B23P 6/00; B23P 23/04

(52) U.S. Cl. 29/402.08; 29/56.5

(57) ABSTRACT

This device comprises: an operating support for repair, provided with mounting means in said intermediate tubular sector, centering means of said operating support for repair, in relation to said tubular end, and repair devices and/or accessories which are prepared for its detachable mounting in said repair operating support. The device may be mounted in a mobile unit which comprises a transport, on which structure the repair means are placed. The method comprises the steps of removing the wheel hub, mounting an operating support in the tubular end to be repaired, mounting a centering gage and measuring and centering the operating support, removing, in the end, the centering gage, mounting on the operating support, a cutting device, and cutting the end sector of the tubular end, dismounting, in the end, the cutting device, machining the tubular end preparing a cavity to wedge a replacement tubular end, heating the tubular end and wedging the replacement tubular end in the cavity.

### FIELD OF THE INVENTION

The present invention is related to a device to repair the tubular end of a vehicle differential, which permits the replacement of the broken part anywhere, even without facilities, workshops or conventional devices available, and which may be easily mounted on a mobile unit, to perform the repair at the same place where the fault occurs. The invention is also related to a method for said repair, applicable with said device.

At the present time, when a vehicle differential tubular end breaks down, the vehicle should be moved to a workshop or facility where suitable machinery and tools are available for the repair. This implies that the vehicle is usually out of service for two or more days.

### BACKGROUND OF THE INVENTION

Consequently, significant damage occurs when the vehicle is a cargo vehicle that has to meet delivery deadlines or passenger vehicles transporting passengers, which, due to the inconvenience, must be transferred to a spare vehicle to maintain the transportation of passengers.

### SUMMARY OF THE INVENTION

The present device includes a set of especially prepared devices and/or repair accessories or apparatus which permit the repair anywhere and in a short period of time. The present invention may even be mounted on a mobile unit, and be moved to the same place where the breakdown occurred in order to repair it on site; and then, the repaired vehicle is left in good conditions to continue operating again.

All these operations may be carried out in a short period of time of two hours or less, and then, the vehicle is again in condition to continue operating. Instead, by means of the traditional techniques and devices, the broken or damaged vehicle may be out of service one or more days.

### DESCRIPTION OF THE DRAWINGS

FIG. 1 is a plan, perspective view of the present device mounted on a mobile unit, in an embodiment in which it is towable;

FIG. 2 is a perspective view in which it can be observed how the operating support is mounted on a tubular end to be repaired;

FIG. 3 comprises a front elevation view, and two cross sections of the operating support which allow observing its components;

FIG. 4 comprises a front view and a lateral view of suitable operating support for vehicles with disk brake systems;

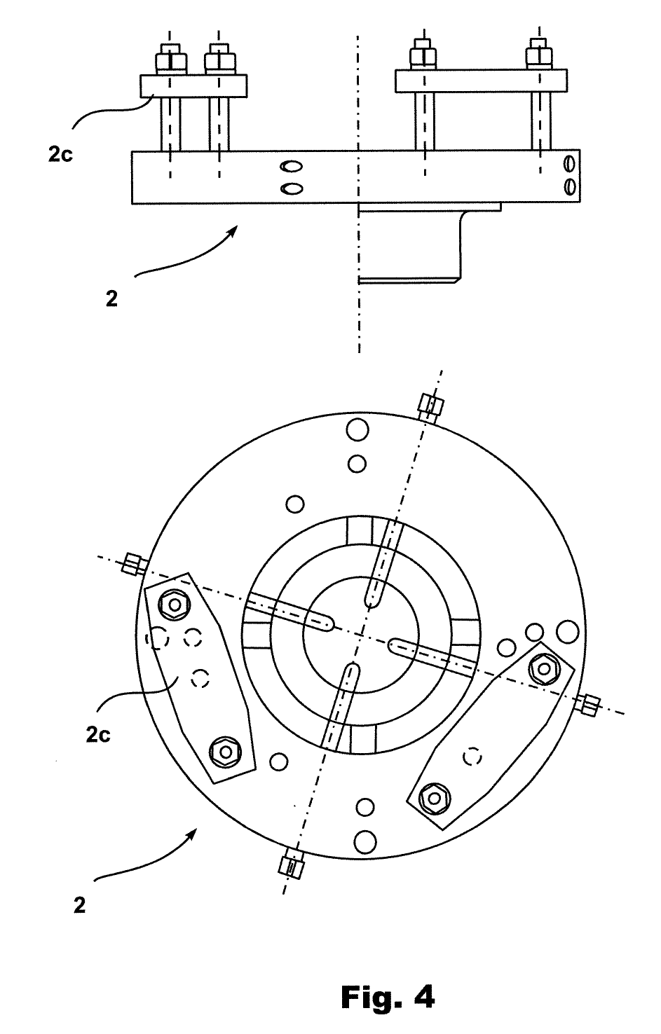

FIG. 5 comprises two cross sections of the operating support of FIG. 3; in one case, assembled for initial centering, and in another case, prepared to provide mounting for other devices and/or accessories;

FIG. 6 is a perspective view of the centering means;

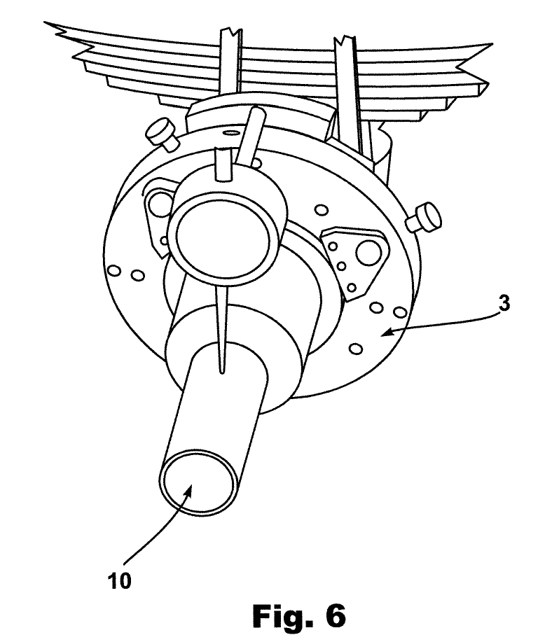

FIG. 7 is a front elevation view of the centering means;

FIG. 8 comprises two cross sections of the centering means of FIGS. 5 and 6;

FIG. 9 is a perspective view of the cutting adaptor support mounted on the operating support;

FIG. 10 is a perspective view of the cutting device;

FIG. 11 is a perspective view of the manual milling device;

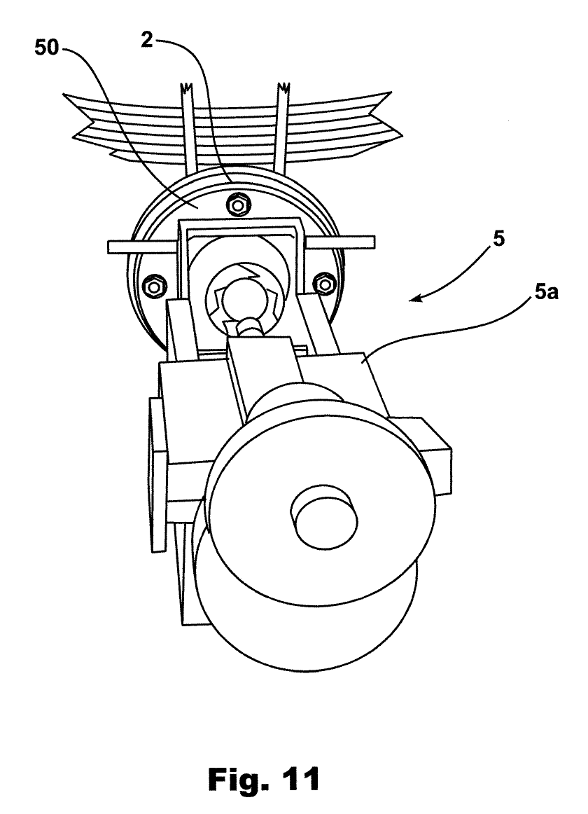

FIG. 12 is another perspective view of the manual milling device with a mounted mobile unit;

FIG. 13 is a perspective view of the automatic milling device provided with a shaft with a keyway;

FIG. 14 is a lateral, elevation view of an inner cutting device;

FIG. 15 is a longitudinal section of the inner cutting device which allows the observation of its components;

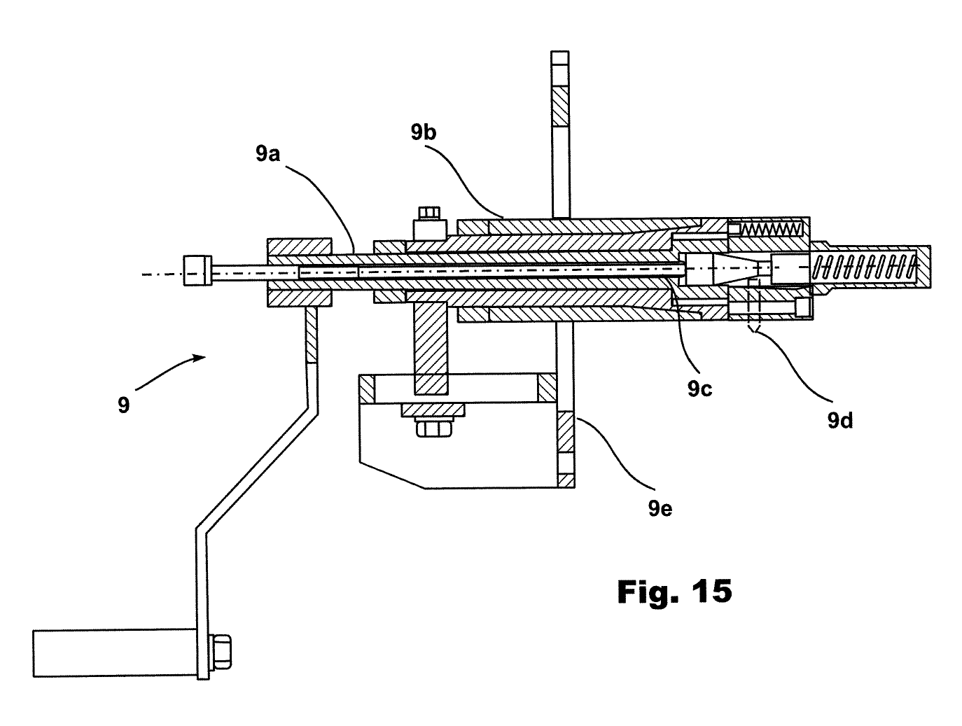

FIG. 16 comprises three cross sections of the inner cutting device;

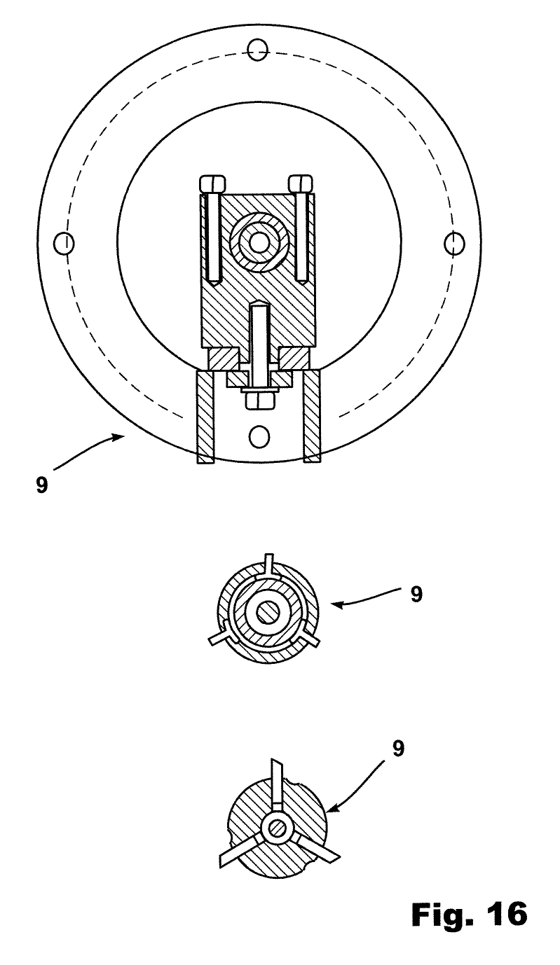

FIG. 17 is perspective view of a parallel turning lathe to adapt the replacement tubular end; and

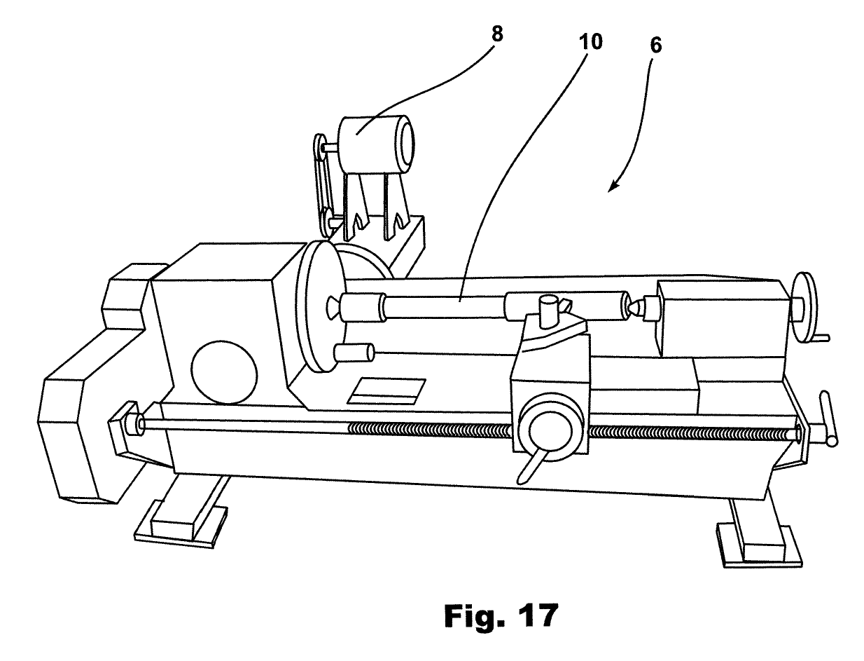

FIG. 18 is a perspective view of a heating blowpipe applied to the cut tubular end where the replacement tubular end is then fitted.

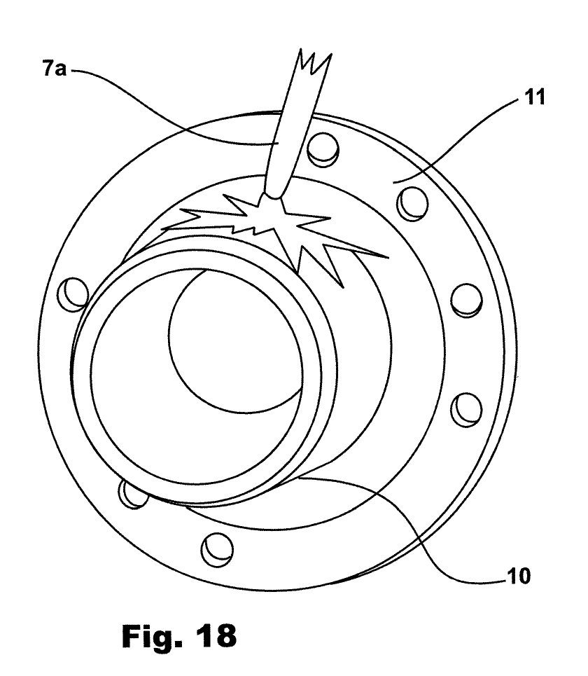

### REFERENCE NUMBERS IN DRAWINGS

### (1) Transport.

(1a) Structure.
(1b) Fixed mounting means.
(2) Operating support.
(2a) Play threading passage.
(2b) Mounting projection.
(2c) Fixing means or clamps.
(2d) Mounting means provided by the operating support (2).
(2e) Cross section regulation passages.
(2f Positioning members.
(2g) Position regulators.
(2h) Auxiliary centering piece.
(3) Centering gage.
(3a) Mobile part.
(3b) Fixed part.
(3c) Turn controller.
(3d) Control means.
(3e) Comparator support.
(3f) Comparator regulator.
(3g) Comparator bar.
(4) Cutting device [power saw].
(5) Milling machines.
(5a) Manual milling machines.
(5b) Automatic milling machines.

### (6) Lathe.

### (7) Blowpipe.

(8) Driving unit.
(9) Inner cutting device.
(9a) Drive shaft.
(9b) Frame.
(9c) Rotary part.
(9d) Inner cutting tool.
(9e) Mounting platen.
(10) Differential tubular end.
(10a) End sector or portion.
(10b) Intermediate sector or portion.

### (30) Comparator.

(40) Cutting adaptor support
(41) Cutter platen.
(42) Lateral mounting of the cutter.
(43) Cutting frame.
(44) Swaying or cutting mechanism.
(50) Milling machine platens.

### DETAILED DESCRIPTION

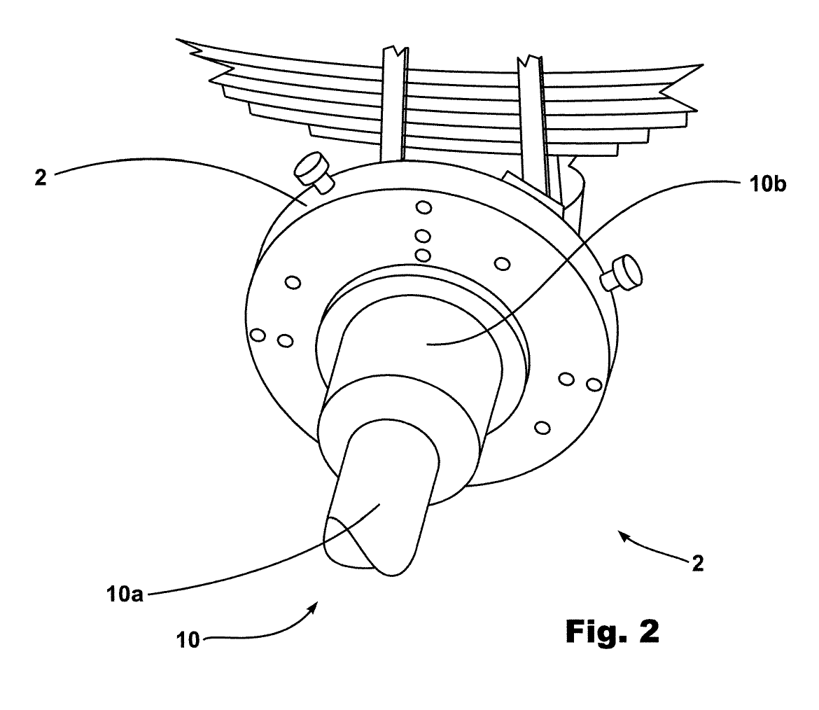

The present device or apparatus for the repair of a vehicle differential with the purpose of making a repair consisting of the replacement of the end sector or portion (10a) of a differential tubular end (10). This tubular end (10) forms a tubular cavity if structurally arranged to receive an axle shaft or spindle that relates the differential mechanism to the wheel hub of the vehicle. The tubular end (10) preferably includes an intermediate tubular sector or portion (10b) wherein the brake supports, a brake plate or the brake system members are usually mounted, as shown in FIG. 2.

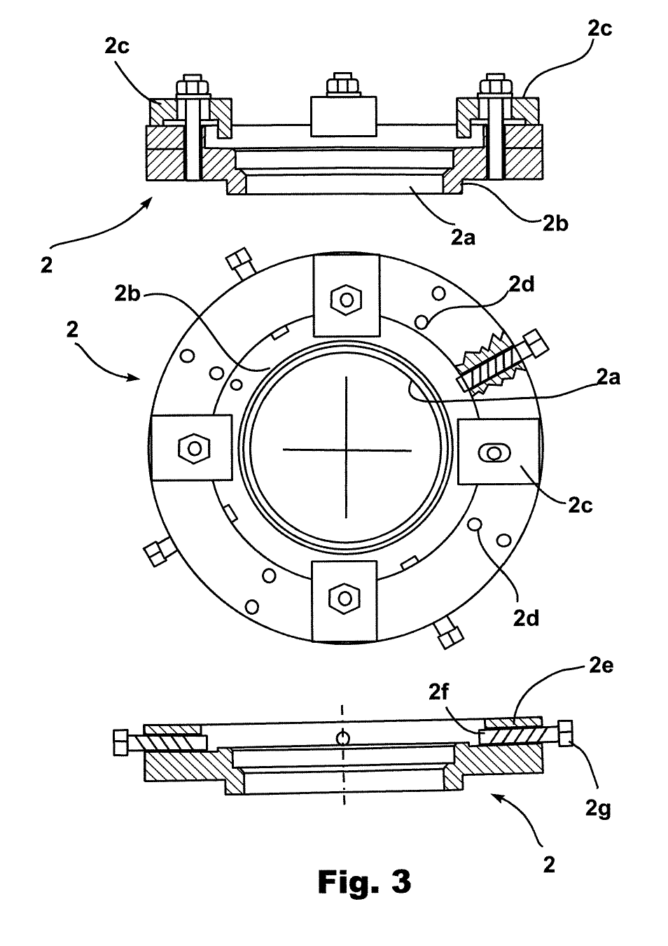

The present device for the repair includes an operating support member (2), which structure provides the mounting means or member (2d) for the device and/or apparatus used for the repair of the differential tabular end, as shown in FIG. 3.

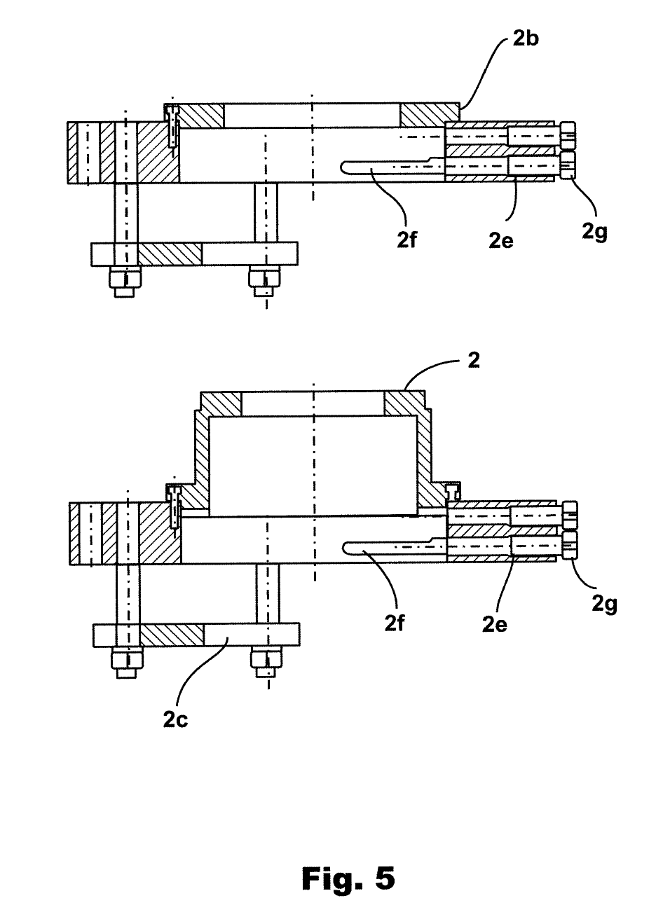

For the correct operating arrangement of the above mentioned operating support member (2), a centering member is provided which permits placing it suitably in relation to the differential tubular end (10). The centering member (2) includes a set of cross-section regulation passages or openings (2e) which are positioned transversally with respect to the axis of the above mentioned differential tubular end (10). In the passages (2e), both the positional regulator members (2g) and positioning members (2f) are engaged thereto. The latter move under the influence of the regulator members (2g) and project through the outlet of the regulation passages (2e) until making contact with the tubular end (10), as shown in FIG. 5. In its central part, the operating support (2) has a play threading passage or opening (2a) which allows its mounting on the tubular end (10) and which is transversally cleared to enable centering thereon, as shown in FIG. 3.

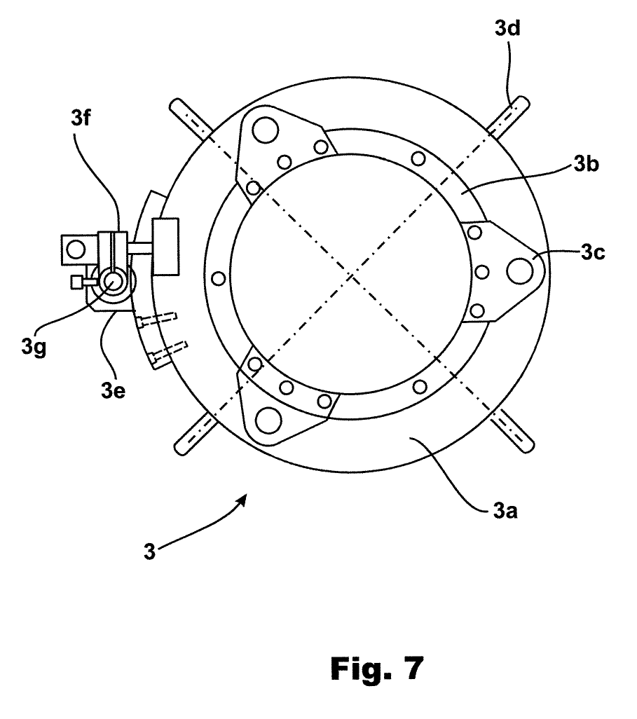

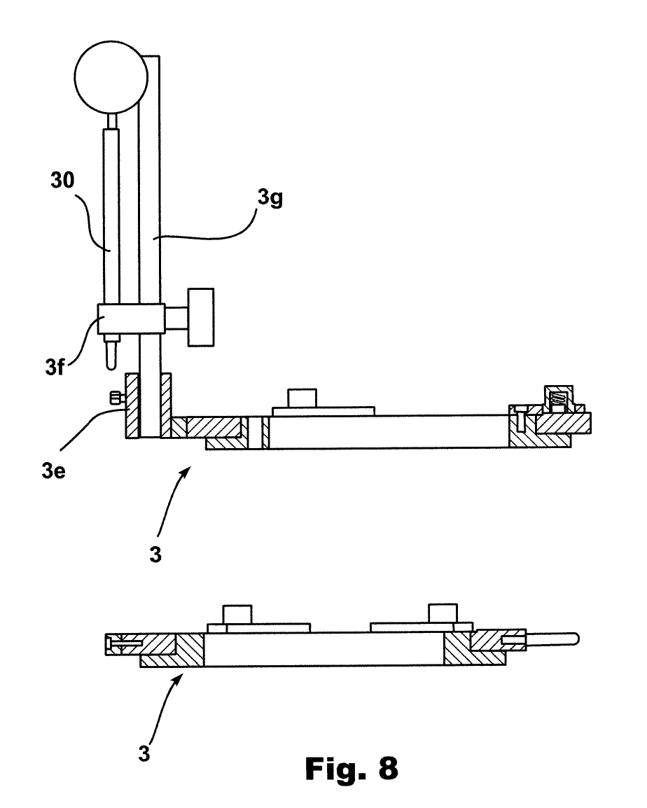

The centering member also includes a centering gage member (3) which is mounted on the operating support (2). This centering gage (3) includes a fixed part or portion (3b) and a mobile part or portion (3a). The fixed part (3b) is mounted in the operating support (2), and the mobile part (3a) includes an arrangement for mounting a comparator member (30), as shown in FIGS. 7 and 8. The mobile part (3a) also has a control member (3d) controlled by turn controllers (3c).

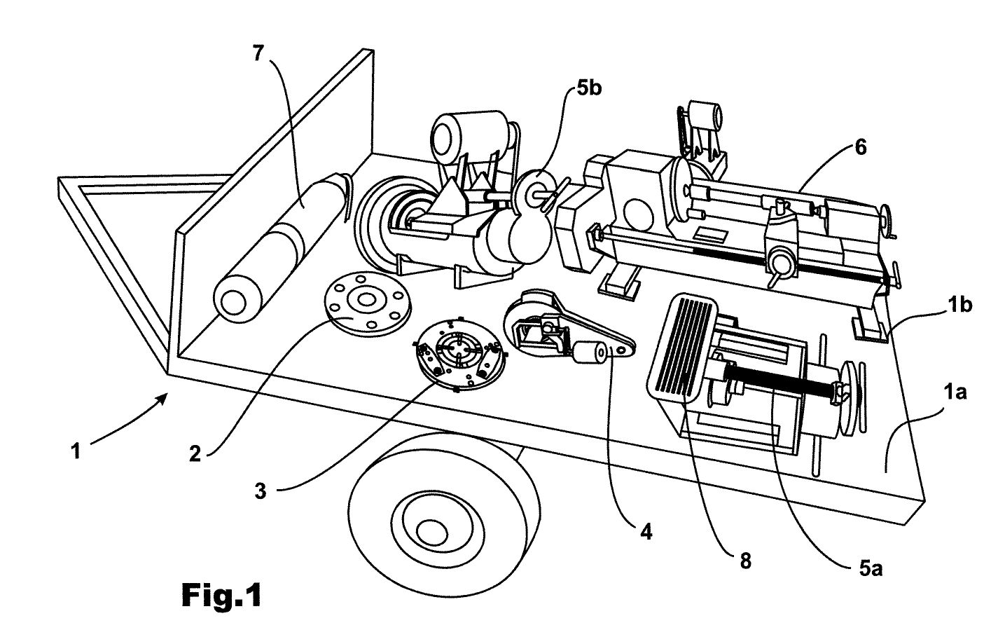

The repair devices and/or repair assembly includes cutting devices (4), inner cutting devices (9), milling devices (5) of the tubular end (10) after cutting, milling devices (6) of the replacement tubular end and heating member (7), as shown in FIG. 1.

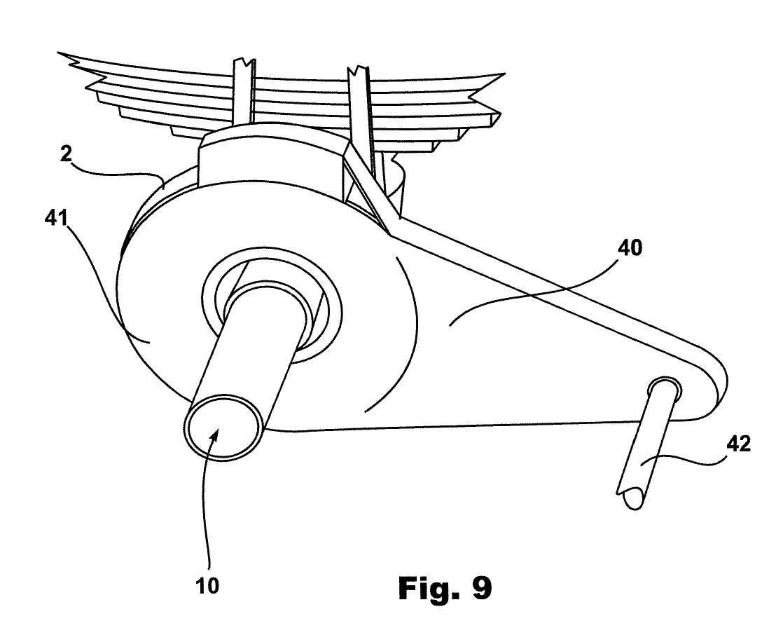

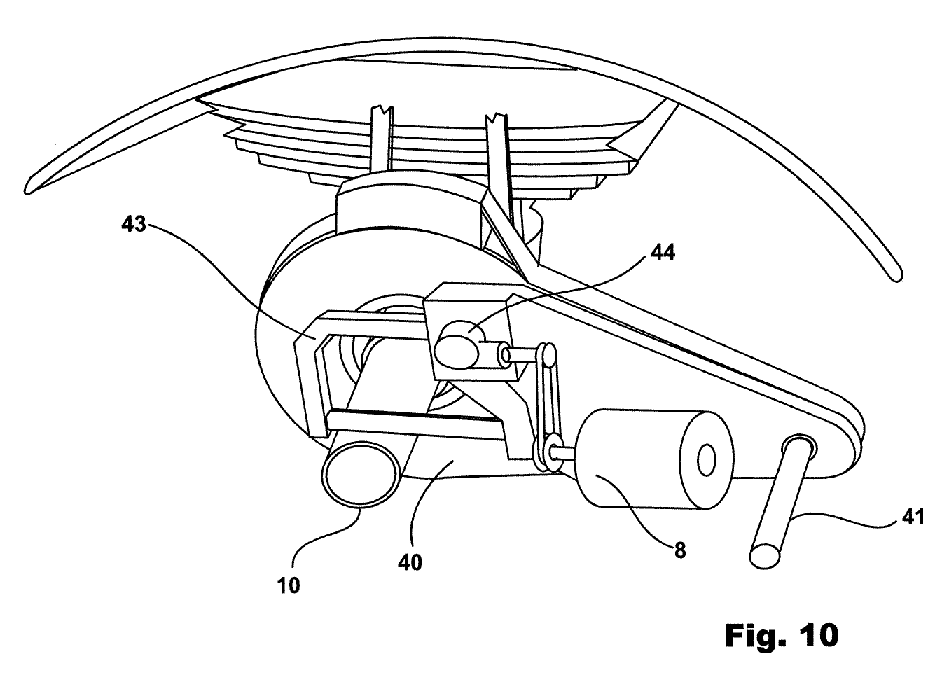

The cutting device (4) may include a power saw provided with a cutting adaptor support (40), able to be mounted on the operating support (2), as shown in FIG. 9. This adaptor support (40) has a cutter platen (41) prepared for mounting and lateral mounting (42) from which the cutting frame is projected (43) until positioned on the application tubular end (10), see FIG. 10.

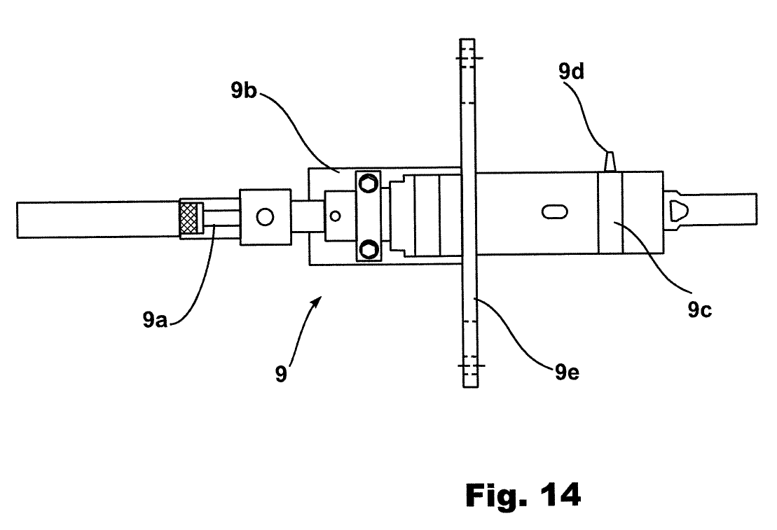

In case it is necessary to remove some existing tubular piece from the tubular end (10), an inner cutting device (9) is structurally arranged, prepared for mounting (9e) in the operating support (2) and provided with rotary cutting means (9c)(9d), see FIG. 14.

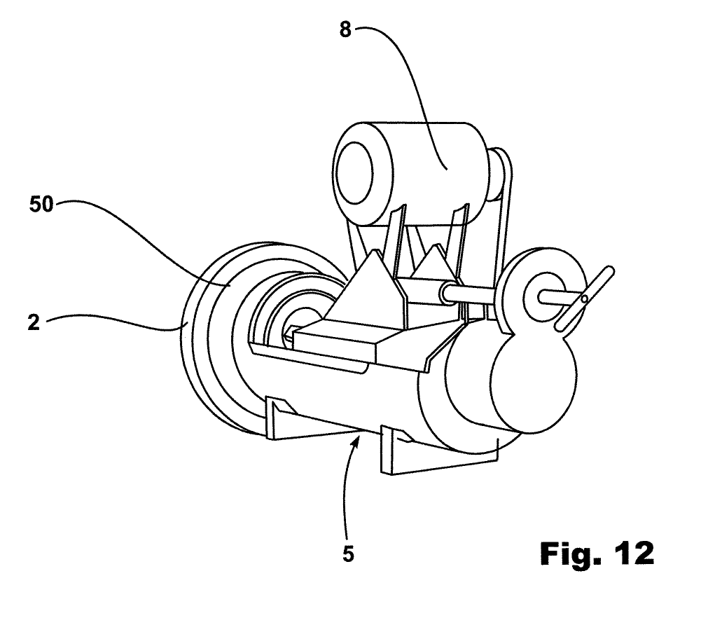

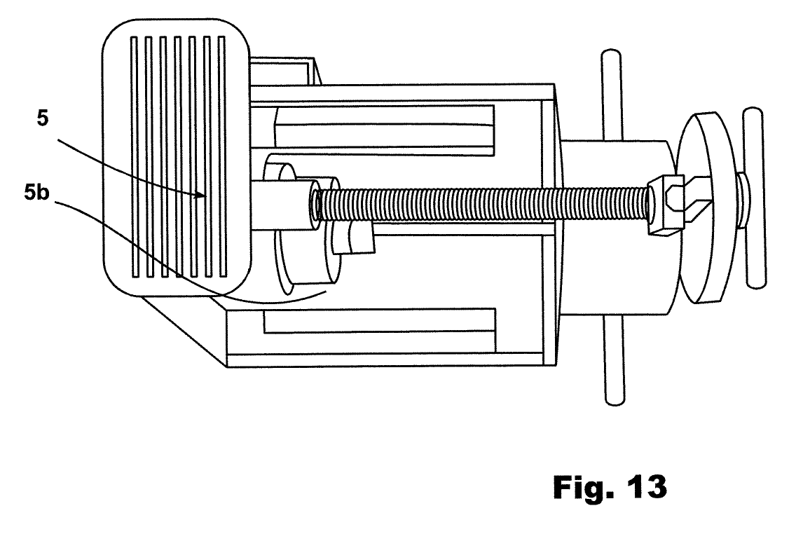

For tooling the tubular end (10), after cutting and removing its end portion, machining devices are used, such as manual (5a) and/or automatic (5b) milling machines (5), as shown in FIGS. 12 and 13. These milling machines (5) are designed to mount on the operating support (2). For that purpose, they may have members, such as compatible platens (50). They also include a structure to permit the milling machine tools remain opposite to the tubular end (10) to be machined, and being able to work inside the tubular end to provide a cavity therein, as well as outside the tubular end to provide a structure to engage and receive the replacement tubular end.

To make the repairs, several members are useful, such as lathes (6) and blowpipes (7), see FIG. 1. The lathes (6) permit the tooling of oversize tubular ends (10) until reaching a size compatible with the cavity formed by a milling machine (5). In these conditions, using a blowpipe (7) allows heating said cavity and then, inserting the replacement tubular end (10).

In a preferred embodiment, the apparatus may be arranged in a mobile unit. This mobile unit comprises a transport (1) that may be self-propelled or towable.

In this latter case, the towable transport (1) comprises a structure (1a) mounted on a rolling and/or sliding frame, which may have such elements as, wheels, skids, etc.. It also has towing means—such as, nozzles, a trailing arm, etc.—which allow its engagement to any type of tractor or trailer vehicles.

On the above mentioned structure (1a) of the transport (1), devices and/or accessories for repair (2)(3)(4)(5)(6)(7)(8)(9)(30)(40) are arranged, which are transported to the place where the repair is performed.

Some of these devices and/or apparatus are mounted only for the purpose of being transported, whereas others may be mounted in a fixed manner (1b) as they are used on the same structure (1a) where they stand.

Among the devices and/or apparatus which are mounted only for the sake of transportation (1), operating supports (2), centering means (2g) (3), and cutting means (4), driving units (8), and blowpipes (7), can be mentioned, as shown in FIG. 1.

Among the devices and/or apparatus that may be mounted in a fixed manner (1b), lathes (6), blowpipe gas tubes (7), electric power sources, such as, generators, batteries, may be utilized.

The method for repairing includes a series of steps which permit cutting and removing of the broken tubular end portion (10a) and replacing it with a new one.

For that purpose, first, the wheel hub is removed and to the tubular end portion (10) of the vehicle differential, the operating support (2) is mounted.

Then, on the operating support (2), a centering gage (3) is mounted. The mobile part (3a) of the centering gage is forced to turn (3a), and by checking the comparator (30), the necessary adjustments are done by means of the position regulators (2g) of said operating support (2). Once this operating support (2) is centered with respect to the tubular end (10), the centering gage (3) is removed.

Thereafter, the cutting device is mounted (4) in the operating support (2) and the broken end portion (10a) is cut. Once the cutting is completed, the cutting device (4) is removed from the operating support.

Afterwards, the cut end portion of the tubular end (10) is machined until forming an appropriate wedging cavity therein. For that operation, initially a manual milling machine (5a) can be used or an automatic milling machine (5b) may be used. The operation may also include machining of the outer portion (10a) of the tubular end to receive a replacement tubular end.

On the other hand, from an oversize replacement tubular end (10), the procedure consists of reducing the tubular end until a size compatible with the machined cavity in the tubular end (10) is achieved.

Afterwards, all the area of the tubular end (10) which is adjacent to the wedging cavity is subject to heating utilizing a blowpipe (7).

Finally, the replacement tubular end is inserted (10) into or about the above mentioned heated cavity. After cooling down, the replacement tubular end will remain securely fixed thereto.

We claim:

1. A device for the repair of the tubular end of a vehicle differential, which comprises the replacement of the tubular end portion of the vehicle differential by forming:
a tubular cavity tubular end portion that is structurally arranged to receive and mount an axle shaft or spindle to the tubular cavity of the differential, which includes:
an operating support member having assemblies engageable with the tubular end portion of the differential,
centering means located on said operating support member for engagement with the tubular end portion of the differential, and
cutting device and position on said operating support member and engageable with the tubular end portion to remove the same and to cut a cavity in the tubular end portion to permit mounting of the replaceable end portion thereto.

2. The device of claim 1, wherein the operating support member is a transport in which center member and cutting devices are placed.

3. The device of claim 2, wherein the transport is towable.

4. The device of claim 2, wherein the transport is self-propelled.

5. The device of claim 1, wherein the operating support member includes, a structure to provide a threading passage in the said tubular end portion, a mounting member engaged with a brake support portion of the differential, and means for mounting apparatus for the repair and centering means of said structure in relation to said tubular end.

6. The device of claim 1, wherein the operating support member, includes:
a structure providing a mounting platform for the assembly for repair of the differential tubular end,
centering means having an initial positioning central piece and a set of regulable transversal positioners; and
a set of fixing clamps to mount said assembly to a brake disk system associated with the differential tubular end.

7. The device of claim 1, wherein the operating support member includes:
a structure providing a mounting platform for the assembly for repairing the differential tubular end,
centering means having a set of regulable transversal positioners, and
a set of fixing members able to mount said structure to a brake plate associated with the differential tubular end portion.

8. The device of claim 1, wherein said cutting devices include sets of openings in the operating support member.

9. The device of claim 8, wherein the means for mounting said cutting devices and/or accessories include sets of threaded openings in the operating support member.

10. The device of claim 8, wherein the means for mounting said cutting devices include threaded elements for the operating support member.

11. The device of claim 1, wherein the operating support member comprises means for mounting the platens associated with said assemblies.

12. The device of claim 1, wherein the centering means on the operating support member, includes:
a set of regulable transversal positioners that, in said operating support, act through a threading passage with transversal play which mounts to the tubular end portion, and
a centering gage relative to the tubular end portion which works mounted in said operating support and comprises a comparator.

13. The device of claim 1, wherein the centering means situated in the operating support include a set of regulable transversal positioners which include:
a transversal regulation passage which virtual axis is transversal to the axis of the tubular end portion,
a position regulator at the entrance of said regulation passage, and
a positioning member that projects through the outlet of said regulation passage until engaging said differential tubular end portion.

14. The device of claim 1, wherein the cutting device includes a power saw provided with a cutting adaptor support member mounted to the operating support member, said adaptor support member including a platen mounted to said operating support member and a lateral assembly from which the cutting assembly projects to engage the tubular end portion.

15. The device of claim 1, includes an inner cutting assembly, comprises rotary cutting members prepared to engage the tubular end.

16. The device of claim 1, includes a manual milling machine mounted on the operating support member and engageable with said tubular end portion.

17. DEVICE of claim 1, which includes an automatic milling machine mounted to the operating support member and engageable with said tubular end portion.

18. The device of claim 1, further including a blowpipe heating member to facilitate receiving the replaceable end portion to the differential.

19. The device of claim 1, which includes means for the tooling adaptation of the replacement tubular end to the differential end.

20. The device of claim 19, wherein the means for the tooling adaptation of the replacement tubular end is a lathe.

21. The device of claim 1, wherein the assemblies for repair include mounting platens engageable with the operating support member of the repair device.

22. A method of repairing a vehicle differential which includes the steps of:
removing the wheel hub member associated with the vehicle differential,
positioning an operating support member adjacent to the tubular end portion of the differential,
mounting a centering gage on said operating support member,
measuring and centering said centering gage mounted on said operating support member to said broken tubular end portion of said differential,
removing said centering gage from said broken tubular end portion,
mounting on said operating support member, a cutting member engageable with said broken tubular end portion and cutting the end portion of the tubular end portion, upon completion of the cutting, removing engagement of said cutting member,
tooling the tubular end portion to provide a cavity therein,
heating the tubular end around said cavity, and
wedging the replacement tubular end into said cavity to secure the same together.

23. The method of claim 22, which further includes the steps:
removing the wheel hub,
mounting an operating support member to the tubular end to be repaired,
mounting a centering gage on said operating support member,
measuring and centering said centering gage mounted on said operating support member, and removing, upon completion, said centering gage therefrom,
mounting on said operating support member, a cutting device and cutting the tubular end portion to be sized to be engaged by a replaceable tubular end portion, dismounting, upon completion of said cutting, removing engagement of said cutting member,
heating the tubular end defined as said cavity; and
wedging the replacement tubular end portion onto said sized tubular end portion to secure the same together.
